(19) United States
(12) Patent Application Publication
(10) Pub. No.: US 2026/0035239 A1
(43) Pub. Date: Feb. 5, 2026

(54) PROCESS OF CARRYING HYDROGEN ON A HYDROGEN CARRIER

(71) Applicant: UOP LLC, Rosemont, IL (US)

(72) Inventors: Ian G. Horn, Streamwood, IL (US); Patrick C. Whitchurch, Sleepy Hollow, IL (US); Ashish Mathur, Gurgaon (IN); Nirlipt Mahapatra, Gurgaon (IN); Dave Lafyatis, Schaumburg, IL (US); Srinivasan Ramanujam, Gurgaon (IN); James W. Harris, Palatine, IL (US)

(21) Appl. No.: 19/246,429

(22) Filed: Jun. 23, 2025

Related U.S. Application Data
(60) Provisional application No. 63/678,046, filed on Jul. 31, 2024.

(51) Int. Cl. C01B 3/00

(52) U.S. Cl. CPC C01B 3/0015; C01B 2203/0277; C01B 2203/062

(57) ABSTRACT

A process of carrying hydrogen on a hydrogen carrier is disclosed. The process comprises hydrogenating a hydrocarbon feed stream in a hydrogenation reactor in the presence of hydrogen and a hydrogenation catalyst to produce a hydrogenated stream for carrying hydrogen. The hydrogenated stream is contacted with a dehydrogenation catalyst to produce a dehydrogenated stream. The dehydrogenated stream is fractionated in a fractionation column to produce a fractionation column overhead stream comprising C7− hydrocarbons and a fractionation column bottoms stream. The hydrocarbon feed stream comprising about 1 to about 10 wt % C₁₂ to C₁₆ hydrocarbons can be taken from the fractionation column bottoms stream. A hydrocarbon composition comprising about 1 to about 10 wt % C₁₂ to C₁₆ hydrocarbons and at least about 80 wt % toluene is also disclosed.

### FIELD

The field is the process of carrying hydrogen on a hydrogen carrier. The field may particularly relate to the process of carrying hydrogen on a hydrogen carrier comprising heavy hydrocarbons.

### BACKGROUND

Hydrogen is expected to have significant growth potential because it is a clean-burning fuel. However, hydrogen production processes based on steam reforming, autothermal reforming, partial oxidation, or gasification of hydrocarbon feedstocks are significant emitters of carbon dioxide. Government regulations and societal pressures are increasingly taxing or penalizing carbon dioxide emissions or incentivizing carbon dioxide capture. Consequently, there is significant interest in lowering the cost of hydrogen production and recovering the byproduct carbon dioxide. The renewed interest in alternative energy sources and energy carriers opens up new prospects for providing hydrogen feed for fuel cells, power generation and many more applications.

Increased global demand for hydrogen requires new modes for transporting hydrogen especially to locations which are hydrogen depleted. Hydrogen generated by renewable energy sources is called green hydrogen. Hydrogen is expected to be an important element in the future fuel economy and may need to be transported to locations as far as 8000 km from the source of generation to remote hydrogen depleted regions.

There exists a huge regional disparity in the cost for production of hydrogen. Several technologies have been developed for transporting hydrogen, including ammonia, liquid hydrogen, and LOHC to address this disparity. Toluene-MCH is expected to be a significant player in LOHC hydrogen storage and release loop considering its easy integration into the existing fuel sector supply chain and distribution network, utilization in idle refinery assets, flexibility for co-processing, and higher relative safety handling.

The process involves the reversible dehydrogenation reaction of a LOHC such as MCH to produce toluene and hydrogen. LOHC hydrogen storage and release loop has been proposed as a solution for the storage, transportation, and distribution of hydrogen produced from renewable or non-renewable energy sources. For power generation, the hydrogen from this process is usually compressed for use in a downstream power generation unit. Usually, purity requirements for power generation units are very stringent. Due to the relatively high cost associated with green hydrogen production, it is necessary to recover almost all of the hydrogen for the process to be economical.

The economics of producing and transporting the produced hydrogen is dependent on various parameters including the relative cost of processing the organic molecules such as toluene and MCH as compared to the relative cost of producing hydrogen. One of the primary determinants of the overall capital expenditure includes the inventory of organic molecules such as toluene and MCH which is required to start up the entire LOHC loop.

Accordingly, it would be desirable to have more effective and efficient ways to purify and transport hydrogen.

### BRIEF SUMMARY

A process for carrying hydrogen on a hydrogen carrier is disclosed. The process comprises hydrogenating a hydrocarbon feed stream in a hydrogenation reactor in the presence of hydrogen and a hydrogenation catalyst to produce a hydrogenated stream for carrying hydrogen. The hydrogenated stream is contacted with a dehydrogenation catalyst to produce a dehydrogenated stream. The dehydrogenated stream is fractionated in a fractionation column to produce a fractionation column overhead stream comprising C₇₋ hydrocarbons and a fractionation column bottom stream. The hydrocarbon feed stream comprising about 1 to about 10 wt % C₁₂ to C₁₆ hydrocarbons can be taken from the fractionation column bottom stream. The disclosed process provides a hydrogen carrier with a greater capacity to carry hydrogen atoms at a lower operational cost. A hydrocarbon composition comprising about 1 to about 10 wt % C₁₂ to C₁₆ hydrocarbons and at least about 80 wt % toluene is also disclosed.

### DEFINITIONS

The term “column” means a distillation column or columns for separating one or more components of different volatilities. Unless otherwise indicated, each column includes a condenser on an overhead of the column to condense and reflux a portion of an overhead stream back to the top of the column and a reboiler at a bottom of the column to vaporize and send a portion of a bottoms stream back to the bottom of the column. Feeds to the columns may be preheated. The top pressure is the pressure of the overhead vapor at the vapor outlet of the column. The bottom temperature is the liquid bottom outlet temperature. Overhead lines and bottoms lines refer to the net lines from the column downstream of any reflux or reboil to the column. Stripper columns may omit a reboiler at a bottom of the column and instead provide heating requirements and separation impetus from a fluidized inert media such as steam. Stripping columns typically feed a top tray and take main product from the bottom.

As used herein, the term “a component-rich stream” means that the rich stream coming out of a vessel has a greater concentration of the component than the feed to the vessel.

As used herein, the term “a component-lean stream” means that the lean stream coming out of a vessel has a smaller concentration of the component than the feed to the vessel.

As used herein, the term “separator” means a vessel which has an inlet and at least an overhead vapor outlet and a bottoms liquid outlet and may also have an aqueous stream outlet from a boot. A flash drum is a type of separator which may be in downstream communication with a separator that may be operated at higher pressure.

As used herein, the term “predominant” or “predominate” or “predominantly” means greater than 50%, suitably greater than 75% and preferably greater than 90%.

The term “Cx” is to be understood to refer to molecules having the number of carbon atoms represented by the subscript “x”. Similarly, the term “Cx−” refers to molecules that contain less than or equal to x and preferably x and less carbon atoms. The term “Cx+” refers to molecules with more than or equal to x and preferably x and more carbon atoms.

As used herein, the term “carbon number” refers to the number of carbon atoms per hydrocarbon molecule and typically a paraffin molecule.

### BRIEF DESCRIPTION OF THE DRAWING

FIG. 1 is an illustration of an exemplary embodiment of a process of carrying hydrogen on a hydrogen carrier.

FIG. 2 is an illustration of another exemplary embodiment of a process of carrying hydrogen on a hydrogen carrier.

### DETAILED DESCRIPTION

The present disclosure provides a process of carrying hydrogen on a hydrogen carrier. The hydrogen carrier can be dehydrogenated to release the hydrogen. The hydrogen carrier disclosed in the process comprises one or more heavier hydrocarbons which are typically separated and not used for carrying hydrogen. Applicants disclose an effective and efficient route to separate the heavier hydrocarbons which have a greater capacity to carry hydrogen atoms than the typical route.

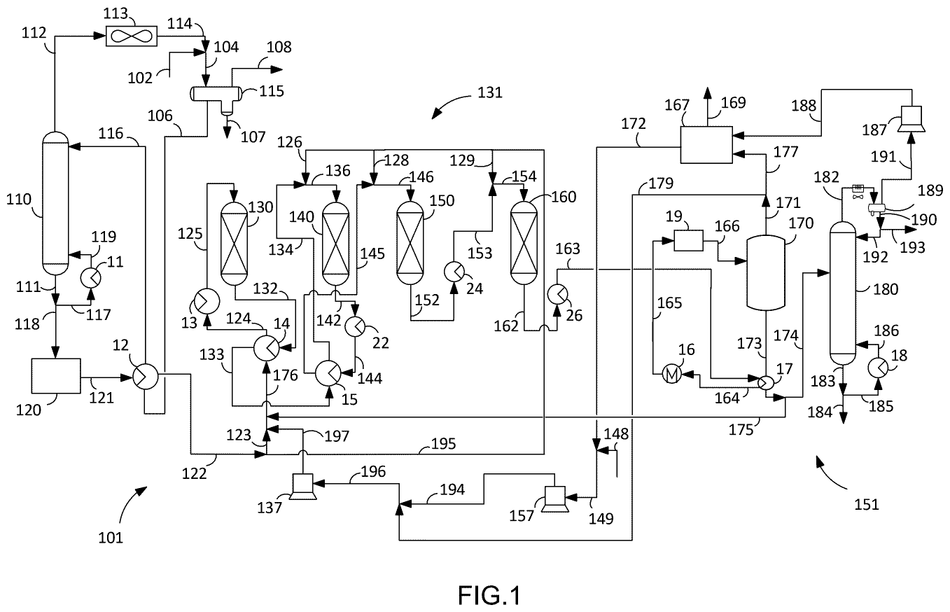

FIG. 1 illustrates an embodiment of the process of carrying hydrogen on a hydrogen carrier. In an aspect, the hydrogenation process 101 represents the hydrogenation cycle of the LOHC loop. The hydrogenation process 101 comprises a hydrogenation section 131 comprising hydrogenation reactor(s) 130, 140, 150, 160 and a purification section 151. As shown, a hydrocarbon feed stream comprising a dehydrogenated hydrocarbon is taken in line 102 and passed to the hydrogenation section 131. The hydrocarbon feed stream in line 102 may comprise one or more hydrogen carriers for carrying the hydrogen after hydrogenation. The hydrocarbon feed stream in line 102 may comprise a dehydrogenated hydrocarbon such as toluene. The dehydrogenated hydrocarbon carries the hydrogen after hydrogenation. As discussed later in detail, the hydrocarbon feed stream in line 102 may comprise heavier dehydrogenated C₁₂ to C₁₆ unsaturated hydrocarbons such as C₁₂ to C₁₆ aromatics, preferably unsaturated C₁₄ hydrocarbons. C12 to C16 unsaturated hydrocarbons may include multi-ring aromatics like methyl-substituted biphenyls and methyl-substituted fluorene. C₁₄ unsaturated hydrocarbons may include C14 aromatics such as dimethyl-biphenyls and methyl-fluorenes. The heavier dehydrogenated C₁₂ to C₁₆ hydrocarbons may be used as feed to the hydrogenation unit to be converted to and used d as a hydrogen carrier along with the other dehydrogenated hydrocarbons such as the toluene. The inclusion of these heavier hydrocarbons in the hydrogen storage and release loop can frequently lead to economic advantages. In an exemplary embodiment, the hydrocarbon feed stream in line 102 may be taken from the dehydrogenation process 201.

The hydrocarbon feed stream in line 102 may be taken from an external source such as a storage tank (not shown). If the hydrocarbon feed stream is imported from an external source, such as through a pipeline, land-going vehicle, or water-going vehicle, the feed stream may be exposed to oxygen and require treatment to remove the oxygen and/or oxygenated hydrocarbons, prior to introduction into the hydrogenation section 131. Such oxygen removal treatments may include but are not limited to oxygen stripping, heat soaking, caustic treatment, adsorption using activated alumina and/or molecular sieves, resins, fractionation, clay treatment, or any combination thereof. The hydrocarbon feed stream in line 102 may be a wet hydrocarbon feed stream. The wet hydrocarbon feed stream can be dried by a treatment step such as passing the wet hydrocarbon feed stream to a stripping column such as the oxygen stripping column. Other treatment steps for drying the wet hydrocarbon feed stream may include drying the wet hydrocarbon feed stream in a drier with molecular sieve.

In an exemplary embodiment, the hydrocarbon feed stream in line 102 may be passed to an oxygen stripping column 110 to remove oxygen and water from the feed stream. In an aspect, the hydrocarbon feed stream in line 102 may be introduced to an overhead receiver 115 of the oxygen stripping column 110. In an embodiment, the hydrocarbon feed stream in line 102 may be combined with a cooled overhead stream of the oxygen stripping column in line 114 to provide a combined overhead stream in line 104. The combined overhead stream in line 104 is passed to the overhead receiver 115. From the overhead receiver 115, an overhead liquid stream is taken in line 106 and passed to the oxygen stripping column 110 preferably near the top of the column. Water may be separated in line 107 from the combined overhead stream and taken from a boot of the overhead receiver 115.

In an embodiment, the overhead liquid stream taken in line 106 may be heated in a heat exchanger 12 by heat exchange with a purified hydrocarbon feed stream in line 121 to provide a heated reflux stream in line 116 and a cooled purified hydrocarbon feed stream in line 122. The heated reflux stream in line 116 may be recycled to the oxygen stripping column 110. The oxygen stripping column 110 may be operated at a bottoms temperature of about 149° C. (300° F.) to about 205° C. (400° F.). Preferably, the oxygen stripping column 110 may be operated at a bottoms temperature of about 177° C. (350° F.) and above to break down the oxygenates. The overhead pressure of the oxygen stripping column 110 may be from about 138 kPa(g) (20 psig) to about 552 kPa(g) (80 psig), preferably about 310 kPa(g) (45 psig) to about 414 kPa(g) (60 psig).

In the oxygen stripping column 110, the heated reflux stream in line 116 comprising the hydrocarbon feed stream in line 102 is stripped of oxygen. An overhead stream containing oxygen and/or oxygenated hydrocarbons is produced in line 112, cooled in a cooler 113 such as an air cooler to provide the cooled overhead stream in line 114. In the receiver 115, oxygen is separated from the cooled overhead stream in line 114 and taken in an off-gas stream in line 108.

A stripped hydrocarbon stream is produced from the bottom of the oxygen stripping column 110 in line 111. A reboiling stream is taken from the stripped hydrocarbon stream in line 117 and heated in a reboiler 11 with steam. A reboiled stream in line 119 is passed back to the oxygen stripping column 110 near the bottom. The remainder of the stripped hydrocarbon stream is taken in line 118 and passed to a guard bed 120. In an embodiment, the guard bed 120 may comprise one or both of zinc oxide and copper oxide which adsorb sulfur compounds from the stripped hydrocarbon stream. In an aspect, the guard bed 120 may include a sulfur guard bed or a chloride treater or both. The purified hydrocarbon feed stream depleted of sulfur is taken in line 121 from the guard bed 120. The purified hydrocarbon feed stream in line 121 is heat exchanged with the overhead liquid stream in line 106 in the heat exchanger 12 to provide a cooled purified hydrocarbon feed stream in line 122 which is passed to the hydrogenation section 131.

In an exemplary embodiment, the hydrogenation section 131 comprises four

hydrogenation reactors, a first hydrogenation reactor 130, a second hydrogenation reactor 140, a third hydrogenation reactor 150, and a fourth hydrogenation reactor 160. In another exemplary embodiment, the hydrogenation section 131 may comprise a polishing reactor 160. Fewer or more hydrogenation reactors than four may be utilized.

In an aspect, the cooled purified hydrocarbon feed stream in line 122 may feed a manifold 195 which provides a first feed stream in line 123, a second feed stream in line 126, a third feed stream in line 128, and a fourth feed stream in line 129.

The first feed stream is taken in line 123 and passed to a first hydrogenation reactor 130. A hydrogen stream in line 197, and, as described later in detail, a recycle stream in line 175 are combined with the first feed stream in line 123 to provide a combined first feed stream in line 176 which is charged to the first hydrogenation reactor 130. The combined first feed stream in line 176 may be heated in a first effluent heat exchanger 14 by heat exchange with a first hydrogenated effluent stream in line 132 to provide a heated first feed stream in line 124. The heated first feed stream in line 124 may be further heated in a start-up heater 13 to provide a twice heated first feed stream in line 125 which is charged to the first hydrogenation reactor 130. The first hydrogenation reactor 130 may be operated in a vapor phase. Optionally, the first hydrogenation reactor 130 may be operated in a mixed phase. In the first hydrogenation reactor 130, the hydrogen carrier including one or more of a dehydrogenated hydrocarbon such as toluene, the heavier dehydrogenated C₁₂ to C₁₆ hydrocarbons, preferably unsaturated C₁₄ hydrocarbons, and a mixture thereof present in the first feed stream is hydrogenated in the presence of hydrogen and a hydrogenation catalyst. The hydrogenation reaction in the first hydrogenation reactor 130 produces a first hydrogenated effluent stream comprising a hydrogenated hydrocarbon such as methylcyclohexane, dimethyl bicyclohexane, methyl perhydrofluorene, or a mixture(s) thereof. The first hydrogenated effluent stream comprising the hydrogenated hydrocarbon is discharged in line 132 from the first hydrogenation reactor 130.

Any suitable hydrogenation catalysts may be used in the first hydrogenation reactor 130. The hydrogenation catalyst should have high selectivity and a low rate of coke lay down. Suitable hydrogenation catalysts for the first hydrogenation reactor 130 may include, but are not limited to, a metal of Group VIII of the Periodic Table, for example, platinum, palladium, rhodium, ruthenium, rhenium, iridium, gold, osmium, silver, or combinations thereof. Optionally, the hydrogenation catalysts may comprise a metal of Group I of the Periodic Table. Suitable hydrogenation catalysts for the first hydrogenation reactor 130 may also include, but are not limited to, 0.05 wt % to 30 wt % of a metal of Group VIII of the Periodic Table and optionally 0.1 wt % to 3 wt % of a metal of Group I of the Periodic Table.

The first hydrogenation reactor 130 may be operated at a pressure of about 1034 kPa(g) (150 psig) to about 6895 kPa(g) (1000 psig), or about 2068 kPa(g) (300 psig) to about 4137 kPa(g) (600 psig). The first hydrogenation reactor 130 may be operated at an inlet temperature of about 150° C. (302° F.) to about 232° C. (450° F.). The first hydrogenation reactor 130 may be operated at an outlet temperature of about 270° C. (518° F.) to about 371° C. (700° F.). During turndown, the first hydrogenation reactor 130 may be operated at an outlet temperature of about 204° C. (400° F.) to about 371° C. (700° F.).

The hydrogenation of the hydrogen carrier including the one or more dehydrogenated hydrocarbon such as toluene, the heavier dehydrogenated C₁₂ to C₁₆ hydrocarbons preferably C₁₄ hydrocarbons and the mixture thereof in the first hydrogenation reactor 130 in the presence of the hydrogenation catalysts is performed at an elevated reaction temperature. The first hydrogenated effluent stream in line 132 exits the first hydrogenation reactor 130 at a high temperature. Heat can be recovered from the first hydrogenated effluent stream in line 132 which may be utilized in the hydrogenation process 101 or exported to other remote locations such as more than about 50 km away from the location of the hydrogenation process 101. In an aspect, the first hydrogenated effluent stream in line 132 may be passed to the first effluent heat exchanger 14 to heat the combined first feed stream in line 176 by heat exchange. A cooled first hydrogenated effluent stream in line 133 from the first effluent heat exchanger 14 may be further heat exchanged with a second hydrogenated effluent stream in line 144 in a second effluent heat exchanger 15 to provide a heated first hydrogenated effluent stream in line 134 which is passed to the second hydrogenation reactor 140 and a cooled second hydrogenated effluent stream in line 145.

In an embodiment, the heated first hydrogenated effluent stream in line 134 is combined with the second feed stream in line 126 to provide a combined second feed stream in line 136 which is charged to the second hydrogenation reactor 140. The second hydrogenation reactor 140 may be operated in a vapor phase. Optionally, the second hydrogenation reactor 140 may be operated in a mixed phase. In the second hydrogenation reactor 140, the hydrogen carrier including the dehydrogenated hydrocarbon such as one or more of the toluene, the heavier dehydrogenated C₁₂ to C₁₆ hydrocarbons preferably C₁₄ hydrocarbons, and the mixture thereof present in the second feed stream in line 126 and in the first hydrogenated effluent stream in line 134 is hydrogenated in the presence of hydrogen and a hydrogenation catalyst to produce a second hydrogenated effluent stream comprising a hydrogenated hydrocarbon such as methylcyclohexane, dimethyl bicyclohexane, methyl perhydrofluorene, or a mixture thereof. Hydrogen for the second hydrogenation reaction in the second hydrogenation reactor 140 may be present in the first hydrogenated effluent stream in line 132. Fresh make-up hydrogen may be supplemented to the second hydrogenation reactor 140, but this is not preferred. The second hydrogenated effluent stream comprising the hydrogenated hydrocarbon is discharged in line 142 from the second hydrogenation reactor 140.

Any suitable hydrogenation catalyst may be used the second hydrogenation reactor 140. The second hydrogenation reactor 140 may comprise one or more of the hydrogenation catalysts previously described. The second hydrogenation reactor 140 may comprise a similar or a different hydrogenation catalyst than the first hydrogenation reactor 130.

The second hydrogenation reactor 140 may be operated at a pressure of about 1034 kPa(g) (150 psig) to about 6895 kPa(g) (1000 psig), or about 2068 kPa(g) (300 psig) to about 4137 kPa(g) (600 psig). The second hydrogenation reactor 140 may be operated at an inlet temperature of about 150° C. (302° F.) to about 232° C. (450° F.). The second hydrogenation reactor 140 may be operated at an outlet temperature of about 270° C. (518° F.) to about 371° C. (700° F.). During turndown, the second hydrogenation reactor 140 may be operated at an outlet temperature of about 204° C. (400° F.) to about 371° C. (700° F.). The second hydrogenation reactor 140 may be operated at similar or different operating pressure and temperature than the first hydrogenation reactor 130.

The second hydrogenated effluent stream in line 142 exits the reactor at a high temperature. Heat can be recovered from the second hydrogenated effluent stream in line 142 which may be utilized in the hydrogenation process 101 or exported to other locations.

In accordance with the present disclosure, the second hydrogenated effluent stream in line 142 may be passed to a third effluent heat exchanger 22 to recover heat from the second hydrogenated effluent stream. For example, the second hydrogenated effluent stream in line 142 may be indirectly heat exchanged with a boiler feed water stream in the third effluent heat exchanger 22 to convert it into steam. Various levels of steam generation can be accommodated in the third effluent heat exchanger 22. Low pressure steam is typically generated at about 241 kPa(g) (35 psig) to about 448 kPa(g) (65 psig). Medium-pressure steam is typically generated at about 2413 kPa(g) (350 psig) to about 3275 kPa(g) (475 psig) and high-pressure steam is typically generated at greater than about 4137 kPa(g) (600 psig).

A heat exchanged, second hydrogenated effluent stream in line 144 from the first steam generator 22 is charged to the third hydrogenation reactor 150. In an aspect, the heat exchanged, second hydrogenated effluent stream in line 144 may be heat exchanged with the cooled first hydrogenated effluent stream in line 133 in the second effluent heat exchanger 15 to provide the heated first hydrogenated effluent stream in line 134 and a cooled second hydrogenated effluent stream in line 145 which is charged to the third hydrogenation reactor 150.

In an embodiment, the cooled second hydrogenated effluent stream in line 145 is combined with the third feed stream in line 128 to provide a combined third feed stream in line 146 which is charged to the third hydrogenation reactor 150. The third hydrogenation reactor 150 may be operated in a vapor phase. Optionally, the third hydrogenation reactor 150 may be operated in a mixed phase. In the third hydrogenation reactor 150, the hydrogen carrier including one or more dehydrogenated hydrocarbon such as toluene, the heavier dehydrogenated C₁₂ to C₁₆ hydrocarbons, preferably C₁₄ hydrocarbons and a mixture thereof present in the third feed stream in line 128 and in the second hydrogenated effluent stream in line 145 is hydrogenated in the presence of hydrogen and a hydrogenation catalyst to produce a third hydrogenated effluent stream comprising a hydrogenated hydrocarbon such as methylcyclohexane, dimethyl bicyclohexane, methyl perhydrofluorene, or a mixture thereof. Hydrogen for the third hydrogenation reaction in the third hydrogenation reactor 150 may be present in the second hydrogenated effluent stream in line 142. Fresh make-up hydrogen may be supplemented to the third hydrogenation reactor 150, but this is not preferred. The third hydrogenated effluent stream comprising the hydrogenated hydrocarbon is discharged in line 152 from the third hydrogenation reactor 150.

Any suitable hydrogenation catalyst may be used in the third hydrogenation reactor

150. The third hydrogenation reactor 150 may comprise one or more of the hydrogenation catalysts as previously described. The third hydrogenation reactor 150 may comprise a similar or a different hydrogenation catalyst than the first hydrogenation reactor 130 and/or the second hydrogenation reactor 140.

The third hydrogenation reactor 150 may be operated at a pressure of about 1034 kPa(g) (150 psig) to about 6895 kPa(g) (1000 psig), or about 2068 kPa(g) (300 psig) to about 4137 kPa(g) (600 psig). The third hydrogenation reactor 150 may be operated at an inlet temperature of about 150° C. (302° F.) to about 232° C. (450° F.). The third hydrogenation reactor 150 may be operated at an outlet temperature of about 270° C. (518° F.) to about 371° C. (700° F.). During turndown, the third hydrogenation reactor 150 may be operated at an outlet temperature of about 204° C. (400° F.) to about 371° C. (700° F.). The third hydrogenation reactor 150 may be operated at similar or different operating pressure and temperature than the first hydrogenation reactor 130 and/or the second hydrogenation reactor 140.

The third hydrogenated effluent stream in line 152 exits the reactor at a high temperature. Heat can be recovered from the third hydrogenated effluent stream in line 152 which may be utilized in the hydrogenation process 101 or exported to other locations.

In accordance with the present disclosure, the third hydrogenated effluent stream in line 152 may be passed to a fourth effluent heat exchanger 24 to recover heat from the third hydrogenated effluent stream. For example, the third hydrogenated effluent stream in line 152 may be indirectly heat exchanged with a boiler feed water stream in the fourth effluent heat exchanger 24 to convert the boiler feed water stream into steam. Various levels of steam generation can be accommodated in the fourth effluent heat exchanger 24.

A cooled third hydrogenated effluent stream in line 153 from the fourth effluent heat exchanger 24 is charged to the fourth hydrogenation reactor 160. In an embodiment, the cooled third hydrogenated effluent stream in line 153 is combined with the fourth feed stream in line 129 to provide a combined fourth feed stream in line 154 which is charged to the fourth hydrogenation reactor 160. In an exemplary embodiment, the fourth hydrogenation reactor 160 is a polishing reactor. The fourth hydrogenation reactor 160 may be operated in a vapor phase. Optionally, the fourth hydrogenation reactor 160 may be operated in a mixed phase.

In the fourth hydrogenation reactor 160, the hydrogen carrier including the one or more dehydrogenated hydrocarbons such as toluene, the heavier dehydrogenated C₁₂ to C₁₆ hydrocarbons, preferably dehydrogenated C₁₄ hydrocarbons and a mixture thereof present in the fourth feed stream in line 129 and in the third hydrogenated effluent stream in line 153 is hydrogenated in the presence of hydrogen and a hydrogenation catalyst to produce a fourth hydrogenated effluent stream comprising a hydrogenated hydrocarbon such as methylcyclohexane, dimethyl bicyclohexane, methyl perhydrofluorene, and mixtures thereof. Hydrogen for the fourth hydrogenation reaction in the fourth hydrogenation reactor 160 may be present in the third hydrogenated effluent stream in line 152. Fresh make-up hydrogen may be supplemented to the fourth hydrogenation reactor 160, but this is not preferred. The fourth hydrogenated effluent stream comprising the hydrogenated hydrocarbon is discharged in line 162 from the fourth hydrogenation reactor 160.

Any suitable hydrogenation catalyst may be used in the fourth hydrogenation reactor 160. The fourth hydrogenation reactor 160 may comprise one or more of the hydrogenation catalysts previously described. The fourth hydrogenation reactor 160 may comprise a similar or a different hydrogenation catalyst than the first hydrogenation reactor 130 and/or the second hydrogenation reactor 140 and/or the third hydrogenation reactor 150.

The fourth hydrogenation reactor 160 may be operated at a pressure of about 1034 kPag (150 psig) to about 6895 kPag (1000 psig), or about 2068 kPag (300 psig) to about 4137 (600 psig). The fourth hydrogenation reactor 160 may be operated at an inlet temperature of about 150° C. (302° F.) to about 232° C. (450° F.). The fourth hydrogenation reactor 160 may be operated at an outlet temperature of about 270° C. (518° F.) to about 371° C. (700° F.). During turndown, the fourth hydrogenation reactor 160 may be operated at an outlet temperature of about 204° C. (400° F.) to about 371° C. (700° F.). The fourth hydrogenation reactor 160 may be operated at similar or different operating pressure and temperature than the first hydrogenation reactor 130 and/or the second hydrogenation reactor 140 and/or the third hydrogenation reactor 150.

The fourth hydrogenated effluent stream in line 162 exits the fourth hydrogenation reactor 160 at a temperature of about the outlet temperature of the fourth hydrogenation reactor 160. Heat can be recovered from the fourth hydrogenated effluent stream in line 162 which may be utilized in the hydrogenation process 101 or exported to other locations.

In accordance with the present disclosure, the fourth hydrogenated effluent stream in line 162 may be passed to a fifth effluent heat exchanger 26 to recover heat from the fourth hydrogenated effluent stream. For example, the fourth hydrogenated effluent stream in line 162 may be indirectly heat exchanged with a boiler feed water stream in the fifth effluent heat exchanger 26 to convert the boiler feed water stream into steam. Various levels of steam generation can be accommodated in the fifth effluent heat exchanger 26.

A first cooled fourth hydrogenated effluent stream comprising the hydrogenated hydrocarbon in line 163 exits from the fifth effluent heat exchanger 26. The first cooled fourth hydrogenated effluent stream in line 163 comprises the hydrogenated hydrocarbon such as methylcyclohexane, dimethyl bicyclohexane, methyl perhydrofluorene, or a mixture thereof, which can be separated in the purification section 151 into a product stream. The purification section 151 comprises a separator 170 and a stabilizer column 180. In an exemplary embodiment, the separator 170 is a high-pressure separator.

In an embodiment, the first cooled fourth hydrogenated effluent stream in line 163 is separated in the separator 170 into a cold liquid stream comprising the hydrogenated hydrocarbon such as methylcyclohexane, dimethyl bicyclohexane, methyl perhydrofluorene, or mixtures thereof and a vapor stream comprising hydrogen. In an aspect, the first cooled fourth hydrogenated effluent stream in line 163 is cooled by heat exchange with a cold liquid stream in line 173 in a separator effluent heat exchanger 17 to provide a second cooled fourth hydrogenated effluent stream in line 164. In another aspect, the second cooled fourth hydrogenated effluent stream in line 164 is heat exchanged in a preheater 16 for example with a boiler feed water stream.

From the preheater 16, a third cooled fourth hydrogenated effluent stream exits in line 165. The third cooled fourth hydrogenated effluent stream in line 165 is further cooled in a cooler 19 to provide a fourth cooled fourth hydrogenated effluent stream in line 166. In an embodiment, the cooler 19 is an air-cooled exchanger. In another embodiment, the cooler 19 is a shell and tube heat exchanger. The fourth cooled hydrogenated effluent stream in line 166 is passed to the separator 170. An overhead vapor stream comprising hydrogen is taken in line 171 from the separator 170. The overhead vapor stream in line 171 may be split into a first overhead vapor stream in line 177 and a second overhead vapor stream in line 179. The first overhead vapor stream in line 177 may be passed to a membrane separator 167. A compressed overhead stream in line 188 is also passed to the membrane separator 167. In an embodiment, the first overhead vapor stream in line 177 may be combined with the compressed overhead stream in line 188 and passed to the membrane separator 167 in a combined line. The membrane separator 167 may comprise one or more membranes. In the membrane separator 167, the first overhead vapor stream in line 177 and the compressed overhead stream in line 188 are separated into a hydrogen rich permeate stream in line 172 and a methane rich retentate stream in line 169. The retentate stream in line 169 may be sent to a fuel gas system or a vent header for safe disposal in a thermal oxidizer. The hydrogen rich permeate stream in line 172 is combined with a make-up hydrogen stream in line 148 to provide a combined make-up hydrogen stream in line 149. The combined make-up hydrogen stream in line 149 may be compressed in a make-up gas compressor 157 to provide a compressed hydrogen stream in line 194. The compressed hydrogen stream in line 194 is combined with the second overhead vapor stream in line 179 to provide a combined hydrogen stream in line 196. The combined hydrogen stream in line 196 is compressed in a recycle compressor 137 to provide the compressed recycle hydrogen stream in line 197. The compressed recycle hydrogen stream in line 197 is combined with the first feed stream in line 123 and passed to the first hydrogenation reactor 130 as described above.

A cold liquid stream comprising the hydrogenated hydrocarbon such as methylcyclohexane, dimethyl bicyclohexane, methyl perhydrofluorene, or a mixture thereof is taken from the bottoms of the separator 170 in line 173. The cold liquid stream in line 173 passed to the separator effluent heat exchanger 17 to heat the first cooled fourth hydrogenated effluent stream in line 163 while cooling the cold liquid stream in line 173. In an aspect, the cold liquid stream in line 173 may be split into a first cold liquid stream in line 174 and a second cold liquid stream in line 175. The second cold liquid stream in line 175 is recycled to the hydrogenation section 131, particularly to the first hydrogenation reactor 130. The second cold liquid stream in line 175 may be combined with the first feed stream in the first feed line 123 and the compressed recycle hydrogen stream in line 197 and passed to the first hydrogenation reactor 130 in the combined first feed line 176. The second cold liquid stream in line 175 is combined with the first feed stream in line 123 to dilute the feed before passing the first feed stream in line 123 to the first hydrogenation reactor 130. Diluting the feed with the second cold liquid stream in line 175 helps in absorbing the exotherm in the hydrogenation section 131 without excessive temperature increase.

The first cold liquid stream in line 174 is fractionated to separate the hydrogenated hydrocarbon such as methylcyclohexane, dimethyl bicyclohexane, methyl perhydrofluorene, or a mixture thereof. The first cold liquid stream in line 174 is fractionated in a stabilizer column 180 to remove dissolved gases that may be present in the first cold liquid stream. The dissolved gases are separated in an overhead stream in line 182 from the stabilizer column 180. The stabilizer overhead stream in line 182 is passed to an overhead receiver 189. An off-gas stream comprising the dissolved gases is taken in line 191 from the overhead receiver 189. A condensed liquid stream is taken in line 190 from the overhead receiver 189. A reflux stream is taken in line 192 and recycled back to the top of the stabilizer column 180. The entirety of the condensed liquid stream in line 190 may be refluxed to the stabilizer column 180 in the reflux line 192. Optionally, an overhead liquid stream may be taken in line 193 from the condensed liquid stream. In an embodiment, the overhead liquid stream in line 193 may comprise C₅-C₆ hydrocarbons. The off-gas stream in line 191 is compressed in an off-gas compressor 187 to provide a compressed overhead stream in line 188. The compressed overhead stream in line 188 may be passed to the membrane separator 167. Optionally, the off-gas stream in line 191 may be sent to a fuel gas system or a vent header for safe disposal in a thermal oxidizer.

A bottom stream comprising the hydrogenated hydrocarbon such as methylcyclohexane, dimethyl bicyclohexane, methyl perhydrofluorene, or a mixture thereof is discharged in line 183 from the stabilizer column 180. A reboiling stream is taken in line 185 from the bottom stream in line 183 and reboiled in a reboiler 18 to provide a reboiled stream in line 186 which is recycled back to the bottom of the stabilizer column 180. A product stream comprising the hydrogenated hydrocarbon such as methylcyclohexane, dimethylbicyclohexane, methyl perhydrofluorene, or a mixture thereof is taken in a product line 184 from the bottoms of the stabilizer column 180. The hydrogenated hydrocarbon in the product stream in line 184 is produced from hydrogenation of the hydrogen carrier present in the hydrocarbon feed stream in line 102. Hydrogen may be harvested from the hydrogenated hydrocarbon such as methylcyclohexane, dimethylbicyclohexane, methyl perhydrofluorene, or a mixture thereof for example by dehydrogenation. In an aspect, the product stream comprising the hydrogenated hydrocarbon such as methylcyclohexane, dimethylbicyclohexane, methyl perhydrofluorene, or a mixture thereof in line 184 may be stored and/or transported to a downstream or a second location for dehydrogenation to toluene, other heavy C₁₀ to C₁₆ dehydrogenated hydrocarbons such as dimethylbiphenyl or methylfluorene, and hydrogen. For example, the hydrogenation step and dehydrogenation step may be located in vastly different geographical locations. So, the product stream comprising the hydrogenated hydrocarbon such as methylcyclohexane in line 184 may be transported from a proximal geographical location to a remote geographical location for dehydrogenation to produce hydrogen at the remote geographical location. The remote location may at least about 1 km, suitably at least about 10 km, more suitably at least about 50 km, and preferably at least about 100 km from the proximal location.

The product stream in line 184 is a hydrogenated hydrogen carrier comprising methylcyclohexane and heavier C₁₂ to C₁₆ hydrocarbons such as C₁₂ to C₁₆ cycloalkanes. In an embodiment, the cycloalkanes are multi-ring cycloalkanes comprising methyl-substituted bicyclohexanes and methyl-substituted perhydrofluorenes. In an exemplary embodiment, the product stream in line 184 comprises C₁₄ cycloalkanes such as dimethyl-bicyclohexanes and methyl-perhydrofluorenes. In another exemplary embodiment, the hydrogenated hydrogen carrier in line 184 may comprise at least about 80 wt % MCH and from about 1 wt % to about 10 wt % C₁₂ to C₁₆ cycloalkanes. In another embodiment, the hydrogenated hydrogen carrier in line 184 may comprise about 1 to about 10 wt % C₁₂ to C₁₆ hydrocarbons and at least about 80 wt % MCH. In aspect, hydrogenated hydrogen carrier in line 184 may comprise about 1 to about 10 wt % C₁₃ to C₁₅ hydrocarbons. In aspect, hydrogenated hydrogen carrier in line 184 may comprise about 1 to about 10 wt % C₁₄ hydrocarbons.

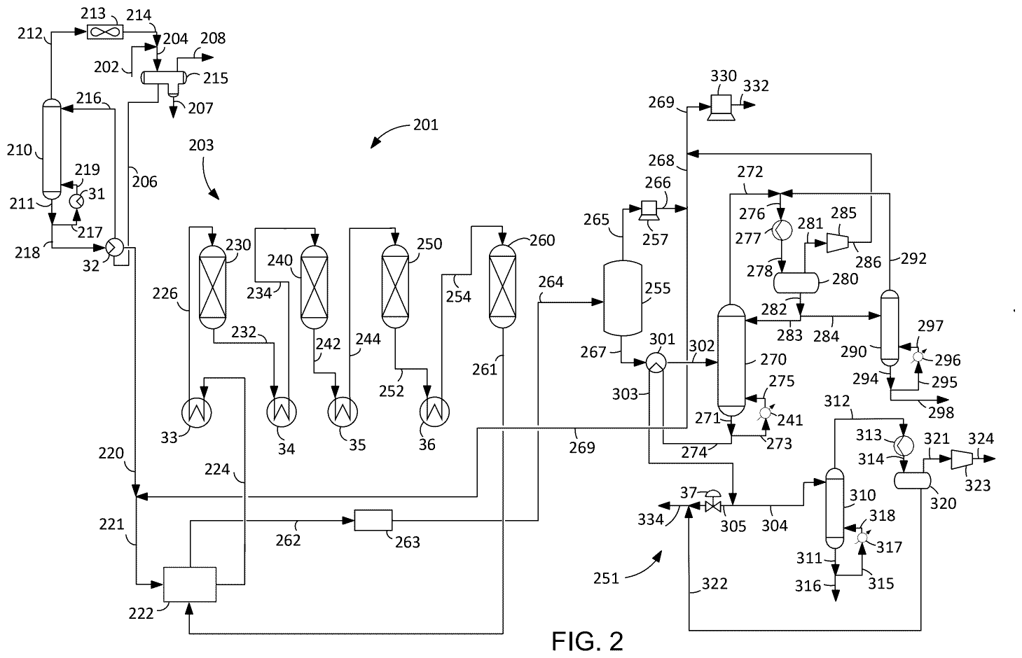

FIG. 2 illustrates another embodiment of the process of carrying hydrogen on a hydrogen carrier. In an aspect, the dehydrogenation process 201 represents the dehydrogenation cycle of the LOHC loop. The dehydrogenation process 201 comprises an oxygen stripping column 210, a combined feed exchanger 222, a dehydrogenation section 203, and a purification section 251. A hydrocarbonaceous feed stream comprising a hydrogenated hydrocarbon such as methylcyclohexane, dimethyl bicyclohexane, methyl perhydrofluorene, or a mixture thereof may be taken in line 202 and charged to the dehydrogenation reaction section 203. In an aspect, the hydrocarbonaceous feed stream comprising the hydrogenated hydrocarbon in line 202 may be taken from a hydrogenation process 101. In an embodiment, the hydrocarbonaceous feed stream in line 202 comprises one or both of methylcyclohexane and dimethylbicyclohexane. In an exemplary embodiment, the hydrocarbonaceous feed stream in line 202 comprises the product stream comprising the hydrogenated hydrocarbon in line 184 taken from the hydrogenation process 101 in FIG. 1. In another exemplary embodiment, the hydrocarbonaceous feed stream in line 202 is the product stream comprising the hydrogenated hydrocarbon in line 184 from the hydrogenation process 101 in FIG. 1.

If the hydrocarbonaceous feed stream may be taken from a storage tank. Alternatively, the hydrocarbonaceous feed stream may be taken from an external source such as a storage tank, a transportation vehicle or a pipeline. When taken from an external source, the hydrocarbonaceous feed stream in line 202 may be passed to the oxygen stripping column 210 to remove oxygen and water and provide a stripped hydrocarbonaceous stream in line 218. The oxygen stripping column 210 may be optional in the embodiment when the hydrocarbonaceous feed stream in line 202 is taken from the hydrogenation process 101 in FIG. 1 without intermediate transport across a long distance. In an embodiment, the hydrocarbonaceous feed stream in line 202 may be combined with a cooled overhead stream of the oxygen stripping column in line 214 to provide a combined overhead stream in line 204. The combined overhead stream in line 204 may be passed to the overhead receiver 215. From the overhead receiver 215, an overhead liquid stream is taken in line 206 and passed to the oxygen stripping column 210 preferably near the top of the column. Water may be separated in line 207 from the combined overhead stream and taken from a boot of the overhead receiver 215.

In an embodiment, the overhead liquid stream taken in line 206 may be heated in a heat exchanger 32 by heat exchange with a purified hydrocarbonaceous feed stream in line 218 to provide a heated reflux stream in line 216 and a cooled purified hydrocarbon feed stream in line 220. The heated reflux stream in line 216 may be recycled to the oxygen stripping column 210. In the oxygen stripping column 210, the heated reflux stream in line 216 comprising the hydrocarbonaceous feed stream in line 202 is stripped of oxygen. An overhead stream containing oxygen and/or oxygenated hydrocarbons is taken in line 212, cooled in a cooler such as an air cooler 213 to provide the cooled overhead stream in line 214. In the overhead receiver 215, oxygen is separated from the cooled overhead stream in line 214 and taken in an off-gas stream in line 208.

A stripped hydrocarbonaceous stream is taken from the bottom of the oxygen stripping column 210 in line 211. A reboiling stream is taken from the stripped hydrocarbonaceous stream in line 217 and heated in a reboiler 31 with steam. A reboiled stream in line 219 is passed back to the oxygen stripping column 210 near the bottom. The remainder of the stripped hydrocarbonaceous stream is taken as the purified hydrocarbonaceous feed stream in line 218. The purified hydrocarbonaceous feed stream in line 218 is heat exchanged with the overhead liquid stream taken in line 206 in the heat exchanger 32 to provide a cooled purified hydrocarbonaceous feed stream in line 220 which is passed to the dehydrogenation section 203.

In an exemplary embodiment, the dehydrogenation section 203 comprises four dehydrogenation reactors, a first dehydrogenation reactor 230, a second dehydrogenation reactor 240, a third dehydrogenation reactor 250, and a fourth dehydrogenation reactor 260. Fewer or more dehydrogenation reactors than four may be utilized.

In an embodiment, the cooled purified hydrocarbonaceous feed stream in line 220 may be combined with a recycle hydrogen stream in line 269 to provide a combined feed stream in line 221. The combined feed stream in line 221 may be passed to the combined feed exchanger 222 to preheat the combined feed stream in line 221 by heat exchange with a fourth dehydrogenated effluent stream in line 261 before passing it to the dehydrogenation section 203. A heated combined feed stream is taken in line 224 from the combined feed exchanger 222 and a cooled fourth dehydrogenated effluent stream is taken in line 262 from the combined feed exchanger 222. Optionally, the cooled purified hydrocarbonaceous feed stream in line 220 and the recycle hydrogen stream in line 269 may be passed to the combined feed exchanger 222 separately.

In an exemplary embodiment, the heated combined feed stream in line 224 is further heated in a first feed heater 33 to provide a twice heated combined feed stream in line 226. The twice heated combined feed stream in line 226 is charged to the first dehydrogenation reactor 230.

The first dehydrogenation reactor 230 may comprise one or more dehydrogenation catalyst bed(s). Any suitable dehydrogenation catalyst that can achieve a selectivity in the dehydrogenation of methylcyclohexane to toluene and hydrogen preferably in excess of 99.8% can be used in the first dehydrogenation reactor 230. Suitable dehydrogenation catalysts may include, but are not limited to, alumina, a noble metal, and an alkali or alkaline earth metal.

Suitable noble metals include, but are not limited to, platinum, palladium, rhodium, ruthenium, rhenium, iridium, gold, osmium, silver, or combinations thereof. Suitable alkali or alkaline earth metals include, but are not limited to, sodium, cesium, potassium, rubidium, francium, lithium, beryllium, strontium, barium, calcium, magnesium, radium, or combinations thereof.

The combined feed stream in line 226 is dehydrogenated in the first dehydrogenation reactor 230 in the presence of the dehydrogenation catalyst to produce a first dehydrogenated effluent stream. The first dehydrogenated effluent stream is discharged in line 232 from the first dehydrogenation reactor 230. The first dehydrogenated effluent stream in line 232 may comprise a dehydrogenated hydrocarbon such as toluene. The first dehydrogenated effluent stream in line 232 may further comprise heavier dehydrogenated C₁₂ to C₁₆ hydrocarbons such as C₁₂ to C₁₆ aromatics along with the toluene. The first dehydrogenated effluent stream in line 232 may also comprise a net hydrogen stream released from the combined feed stream in the first dehydrogenation reactor 230. In an embodiment, the C₁₂ to C₁₆ aromatics may include multi-ring C₁₂ to C₁₆ aromatics such as methyl-substituted biphenyl and methyl-substituted fluorenes. Preferably, the first dehydrogenated effluent stream in line 232 may include C₁₄ aromatics such as dimethyl-biphenyls and methyl-fluorenes.

The first dehydrogenated effluent stream in line 232 may be further dehydrogenated in the second dehydrogenation reactor 240. The first dehydrogenated effluent stream in line 232 may be heated in a second feed heater 34 to provide a heated first dehydrogenated effluent stream in line 234. The heated first dehydrogenated effluent stream in line 234 is passed to the second dehydrogenation reactor 240. The second dehydrogenation reactor 240 may comprise one or more dehydrogenation catalyst bed(s). The second dehydrogenation reactor 240 may comprise similar or different dehydrogenation catalyst than the first dehydrogenation reactor 230.

The first dehydrogenated effluent stream in line 234 is dehydrogenated in the second dehydrogenation reactor 240 in the presence of the dehydrogenation catalyst to produce a second dehydrogenated effluent stream. The second dehydrogenated effluent stream is taken in line 242 from the second dehydrogenation reactor 240. The second dehydrogenated effluent stream in line 242 may comprise a dehydrogenated hydrocarbon such as toluene. The second dehydrogenated effluent stream in line 242 may further comprise heavier dehydrogenated C₁₂ to C₁₆ hydrocarbons such as C₁₂ to C₁₆ aromatics along with the toluene. The second dehydrogenated effluent stream in line 242 may also comprise a net hydrogen stream released from the first dehydrogenated effluent stream in the second dehydrogenation reactor 240. In an embodiment, the C₁₂ to C₁₆ aromatics may include multi-ring C₁₂ to C₁₆ aromatics such as methyl-substituted biphenyl and methyl-substituted fluorenes. Preferably, the second dehydrogenated effluent stream in line 242 may include C₁₄ aromatics such as dimethyl-biphenyls and methyl-fluorenes.

The second dehydrogenated effluent stream in line 242 may be further dehydrogenated in the third dehydrogenation reactor 250. The second dehydrogenated effluent stream in line 242 may be heated in a third feed heater 35 to provide a heated second dehydrogenated effluent stream in line 244. The heated second dehydrogenated effluent stream in line 244 is passed to the third dehydrogenation reactor 250. The third dehydrogenation reactor 250 may comprise one or more dehydrogenation catalyst bed(s). The third dehydrogenation reactor 250 may comprise similar or different dehydrogenation catalyst than the first dehydrogenation reactor 230 and/or the second dehydrogenation reactor 240.

The heated second dehydrogenated effluent stream in line 244 is dehydrogenated in the third dehydrogenation reactor 250 in the presence of the dehydrogenation catalyst to produce a third dehydrogenated effluent stream. The third dehydrogenated effluent stream is taken in line 252 from the third dehydrogenation reactor 250. The third dehydrogenated effluent stream in line 252 may comprise a dehydrogenated hydrocarbon such as toluene. The third dehydrogenated effluent stream in line 252 may further comprise heavier dehydrogenated C₁₂ to C₁₆ hydrocarbons such as C₁₂ to C₁₆ aromatics along with the toluene. The third dehydrogenated effluent stream in line 252 may also comprise a net hydrogen stream released from the second dehydrogenated effluent stream in the third dehydrogenation reactor 250. In an embodiment, the C₁₂ to C₁₆ aromatics may include multi-ring C₁₂ to C₁₆ aromatics such as methyl-substituted biphenyl and methyl-substituted fluorenes. Preferably, the third dehydrogenated effluent stream in line 252 may include C₁₄ aromatics such as dimethyl-biphenyls and methyl-fluorenes.

The third dehydrogenated effluent stream in line 252 may be further dehydrogenated in the fourth dehydrogenation reactor 260. The third dehydrogenated effluent stream in line 252 may be heated in a fourth feed heater 36 to provide a heated third dehydrogenated effluent stream in line 254. The heated third dehydrogenated effluent stream in line 254 is passed to the fourth dehydrogenation reactor 260. The fourth dehydrogenation reactor 260 may comprise one or more dehydrogenation catalyst bed(s). The fourth dehydrogenation reactor 260 may comprise similar or different dehydrogenation catalyst than the first dehydrogenation reactor 230 and/or the second dehydrogenation reactor 240 and/or the third dehydrogenation reactor 250.

The third dehydrogenated effluent stream in line 254 is dehydrogenated in the fourth dehydrogenation reactor 260 in the presence of the dehydrogenation catalyst to produce a fourth dehydrogenated effluent stream. The fourth dehydrogenated effluent stream is taken in line 261 from the fourth dehydrogenation reactor 260. The fourth dehydrogenated effluent stream in line 261 may comprise a dehydrogenated hydrocarbon such as toluene. The fourth dehydrogenated effluent stream in line 261 may further comprise heavier dehydrogenated C₁₂ to C₁₆ hydrocarbons such as C₁₂ to C₁₆ aromatics along with the toluene. The fourth dehydrogenated effluent stream in line 261 may also comprise a net hydrogen stream released from the third dehydrogenated effluent stream in the fourth dehydrogenation reactor 260. In an embodiment, the C₁₂ to C₁₆ aromatics may include multi-ring C₁₂ to C₁₆ aromatics such as methyl-substituted biphenyl and methyl-substituted fluorenes. Preferably, the fourth dehydrogenated effluent stream in line 261 may include C₁₄ aromatics such as dimethyl-biphenyls and methyl-fluorenes.

The fourth dehydrogenated effluent stream in line 261 comprising the dehydrogenated hydrocarbon is passed to the combined feed exchanger 222 to be heat exchanged with the combined feed stream in line 221 to heat the combined feed stream. A cooled fourth dehydrogenated effluent stream is taken in line 262 from the combined feed exchanger 222.

The cooled fourth dehydrogenated effluent stream in line 262 may be further cooled in a cooler 263 to provide a twice cooled fourth dehydrogenated effluent stream in line 264. In an embodiment, the cooler 263 is an air-cooled exchanger. In an embodiment, the cooler 263 is a shell and tube heat exchanger. In another embodiment, the cooler 263 is a water-cooled, heat exchanger.

The reactions taking place in the reactors of the dehydrogenation section 203 may include a main reaction of dehydrogenation of the hydrogenated hydrocarbon such as methylcyclohexane or dimethyl bicyclohexane to toluene or dimethyl biphenyl releasing hydrogen and may include one or more side reactions. One side reaction includes cracking of toluene to benzene and methane. Another side reaction includes isomerization of the hydrogenated hydrocarbon such as methylcyclohexane to dimethylcyclopentane (DMCP), and ethylcyclopentane (ECP). A third side reaction includes the dimerization of toluene to heavier molecules, such as biphenyl compounds like dimethyl biphenyls and fluorenes like methylfluorene. These side reactions may affect the overall yield and the purity of the products streams of the dehydrogenation process 201. The purification section 251 separates byproducts from the products streams to promote the purity of the product streams while consuming a minimum energy in the separation.

In an embodiment, the purification section 251 comprises, a fractionation column 270, a stabilizer column 290, and a rerun column 310. The twice cooled fourth dehydrogenated effluent stream in line 264 is passed to the separator 255 of the dehydrogenation section 203 to separate the twice cooled fourth dehydrogenated effluent stream in line 264 comprising the dehydrogenated hydrocarbon such as toluene, biphenyls and heavier hydrocarbons such as C₁₂ to C₁₆ hydrocarbons into vapor and liquid streams. The twice cooled fourth dehydrogenated effluent stream in line 264 is passed to the separator 255 where it is separated into a separator vapor stream comprising hydrogen in line 265 and a dehydrogenated separator liquid stream comprising toluene and heavy materials in line 267. The separator vapor stream in line 265 may comprise methane and traces of C7-hydrocarbons along with the hydrogen. The separator vapor stream in line 265 may be compressed in a recycle compressor 257 to provide a compressed vapor stream in line 266. The recycle hydrogen stream is taken in line 269 from the compressed vapor stream in line 266. The remaining portion of the compressed separator vapor stream is taken in line 268, combined with a compressed offgas stream in line 286 and passed in a combined gas line 329 to a hydrogen compressor 330 where it is compressed to provide a hydrogen product stream which is taken in line 332.

The dehydrogenated separator liquid stream in line 267 is a toluene rich liquid stream. The dehydrogenated separator liquid stream in line 267 is passed to the fractionation column 270 of the purification section 251. In an embodiment, the dehydrogenated separator liquid stream in line 267 is passed to a fractionator feed exchanger 301, which exchanges heat from fractionator column bottoms stream in line 274 to produce a heated dehydrogenated separator liquid stream in line 302 and a cooled fractionator column bottoms stream in line 303. The heated dehydrogenated separator liquid stream in line 302 is then passed to the fractionation column 270.

In an embodiment, the dehydrogenated separator liquid stream in line 267 is fractionated in the fractionation column 270 to provide a fractionation column overhead stream in line 272 and a fractionation column bottoms stream in line 271. The fractionation column bottoms stream in line 271 comprises the dehydrogenated hydrocarbon such as toluene and the heavier dehydrogenated hydrocarbons such as C₁₂ to C₁₆ unsaturated hydrocarbons such as biphenyl compounds. In an exemplary embodiment, the fractionation column 270 is a deheptanizer column. The fractionation column overhead stream in line 272 may comprise C₇₋ hydrocarbons. The fractionation column overhead stream in line 272 may comprise methane and traces of C₇₋ hydrocarbons along with the product hydrogen. In an embodiment, the fractionation column overhead stream in line 272 may comprise benzene and C₇₋ saturated hydrocarbons including hexanes, methylcyclopentane, cyclohexane, heptane, dimethylcyclopentane, methylcyclohexane, and ethylcyclopentane. In another embodiment, the fractionation column overhead stream in line 272 may comprise light hydrocarbons for example C₃₋ hydrocarbons, and/or C₂₋ hydrocarbons. Some toluene may slip into the fractionation column overhead stream in line 272. The fractionation column overhead stream in line 272 may also comprise trace amounts of hydrogen and methane.

In an exemplary embodiment, the fractionation column 270 may be operated at an overhead pressure of about 34 kPa(g) (5 psig) to about 207 kPa(g) (30 psig) and a bottoms temperature of about 93° C. (200° F.) to about 177° C. (350° F.). In an aspect, the heat to the fractionation column 270 may be supplied from a reboiler 241 using steam.

The fractionation column overhead stream in line 272 may be passed to the stabilizer column 290 to separate one or more of hydrogen, methane and C₆₋ hydrocarbons. In an aspect, the fractionation column overhead stream in line 272 may be combined with a stabilizer column overhead stream in line 292 to provide a combined overhead stream in line 276. The combined overhead stream in line 276 may be cooled in an overhead heat exchanger 277 and a cooled overhead stream in line 278 is passed to an overhead receiver 280. The cooled overhead stream in line 278 may be totally or partially condensed entering the overhead receiver 280 to provide a condensed overhead liquid stream in line 282 and an off-gas stream in line 281. A reflux stream is taken in line 283 from the condensed overhead liquid stream in line 282 and returned to the fractionation column 270 near the top.

A fractionation column overhead liquid stream is taken in line 284 from the condensed overhead liquid stream in line 282. The fractionation column overhead liquid stream in line 284 is a net liquid stream from the overhead receiver 280. The net liquid stream in line 284 is passed to the stabilizer column 290. The stabilizer column removes the byproducts and/or impurities from the process in a bottoms stream in line 294. In an aspect, the stabilizer column bottoms stream in line 294 may comprise benzene and C7− saturated hydrocarbons such as hexane, methylcyclopentane, cyclohexane, heptane, dimethylcyclopentane, methylcyclohexane, and ethylcyclopentane. The stabilizer column overhead stream in line 292 may comprise hydrogen and methane. The stabilizer column overhead stream in line 292 may be recycled. The stabilizer column overhead stream in line 292 may be combined with the fractionation column overhead stream in line 272 to provide the combined overhead stream in line 276 and passed to the overhead receiver 280. The offgas stream may be taken in line 281 from the overhead receiver 280, compressed in an overhead compressor 285 to provide a compressed offgas stream in line 286. The compressed offgas stream in line 286 may comprise hydrogen and methane. The compressed offgas stream in line 286 may be used in the process. For example, the compressed offgas stream may be burned to provide heat to the reactor or the column or it may be sent to an off-site utility. In an embodiment, a portion or an entirety of the compressed offgas stream in line 286 may be taken along with the compressed separator vapor stream in line 268 and passed to the hydrogen compressor 330 in line 329 to be compressed to provide the hydrogen product stream in line 332. In an embodiment, a portion or an entirety of the compressed offgas stream in line 286 may be combined with the compressed vapor stream in line 266 to be split to provide the recycle hydrogen stream in line 269 and the remaining portion of the compressed separator vapor stream in line 268.

In an embodiment, the stabilizer column 290 may be operated at an overhead pressure of about 34 kPa(g) (5 psig) to about 207 kPa(g) (30 psig) and a bottoms temperature of about 65° C. (150° F.) to about 122° C. (250° F.). In an aspect, the heat to the stabilizer column 290 may be supplied from a reboiler 296 using steam. A reboil stream is taken in line 295 from a stabilizer column bottoms stream in line 294. The reboil stream in line 295 is heated in the reboiler 296 and a reboiled stream in line 297 is returned to the stabilizer column 290 near the bottom. A stabilizer column net bottoms stream is taken in line 298.

Referring back to the fractionation column 270, a reboil stream is taken in line 273 from the fractionation column bottoms stream in line 271. The reboil stream in line 273 is heated in the reboiler 241 and a reboiled stream in line 275 is returned to the fractionation column 270 near the bottom. A fractionation column net bottoms stream is taken in line 274. The fractionation column bottoms stream in line 274 may comprise the dehydrogenated hydrocarbons such as toluene and the heavier unsaturated hydrocarbons such as C₁₂ to C₁₆ hydrocarbons including biphenyl compounds. In an exemplary embodiment, the fractionation column bottoms stream in line 274 may comprise about 1 wt % to about 10 wt % C₁₂ to C₁₆ unsaturated hydrocarbons. In an embodiment, the fractionation column net bottoms stream in line 274 may be cooled in the fractionator feed exchanger 301 to produce a cooled fractionation column net bottoms stream in line 303.

In an aspect, the cooled fractionation column net bottoms stream in line 303 may be split to provide a liquid product stream in line 305 and a rerun column feed stream in line 304. The liquid product stream in line 305 may predominantly comprise toluene. A control valve 37 is provided on the liquid product line 305 to regulate the flow of the liquid product stream. The rerun column feed stream in line 304 is processed to separate the toluene from heavier unsaturated hydrocarbons. In an embodiment, the rerun column feed stream in line 304 may be passed to the rerun column 310 to separate heavier unsaturated hydrocarbons from the toluene.

Typically, the rerun column separates predominantly the C₁₂ to C₁₆ unsaturated hydrocarbons present in the rerun column feed stream in line 304 into a rerun overhead stream in line 312 and rerun column bottoms stream in line 311. C7 or toluene present in the rerun column feed stream in line 304 is separated predominantly into the rerun column overhead stream in line 312 which is separated and may be recycled to carry further hydrogen in the hydrogenation loop.

The heavier hydrocarbons such as C₁₂ to C₁₆ unsaturated hydrocarbons are formed as a byproduct of the dehydrogenation reaction. The heavy unsaturated hydrocarbons are usually separated and not used further in the LOHC loop as a hydrogen carrier for carrying hydrogen. Applicants have found that the inclusion of the heavy unsaturated hydrocarbons in the LOHC loop in addition to toluene can be used to carry more hydrogen and improve the efficiency of this loop as compared to toluene in the absence of these C₁₂ to C₁₆ unsaturated hydrocarbons. The heavy unsaturated hydrocarbons may include C₁₂ to C₁₆ unsaturated hydrocarbons comprising C₁₂ to C₁₆ aromatics preferably C₁₄ unsaturated hydrocarbons comprising C₁₄ aromatics such as biphenyls including isomers of dimethylbiphenyl and methyl-fluorenes. The heavy unsaturated hydrocarbons can carry about 14 lb-mol H₂/bbl compared to toluene which can carry 10 lb-mol H₂/bbl. So, the heavy unsaturated hydrocarbons have a greater capacity to carry hydrogen atoms than the C₇ hydrocarbons. Some of the heavy unsaturated hydrocarbons are allowed to enter into the rerun column overhead stream along with the toluene and used as a hydrogen carrier. Hydrocarbons heavier than the C₁₂ to C₁₆ hydrocarbons for example C₁₈₊ hydrocarbons are separated in the rerun column bottoms stream in line 311.

For this embodiment, the proposed process includes running the rerun column 310 at a lower intensity such as at a lower operating pressure than typical to promote the leakage of the heavy unsaturated hydrocarbons from the rerun column feed stream in line 304 into the rerun column overhead stream in line 312. The rerun column overhead stream comprising the heavy unsaturated hydrocarbons may be further routed to the hydrogenation process 101 to carry hydrogen. So, the rerun column 310 may be operated at a lower intensity than necessary to send all the C₁₂ to C₁₆ hydrocarbons to the bottoms line 311. This embodiment enables the rerun column to be run at lower operational cost than when all the C₁₂ to C₁₆ hydrocarbons separated in the bottoms line 311. Applicants calculated that this operation reduces the energy cost of the separation by about 20% in the dehydrogenation unit by admitting the heavy hydrocarbons such as C₁₂ to C₁₆ hydrocarbons into the rerun column overhead stream.

In an embodiment, the rerun column 310 may be operated at an overhead pressure of below atmospheric pressure or vacuum pressure. In an exemplary embodiment, the rerun column 310 may be operated at an overhead pressure of about 34 kPa (a) (5 psia) to about 95 kPa (a) (14 psia) or about 1.4 kPa (a) (0.2 psia) to about 34 kPa (a) (5 psia). In another exemplary embodiment, the rerun column 310 may be operated at atmospheric pressure. In an embodiment, the rerun column 310 may be operated at a bottom temperature of about 65° C. (150° F.) to about 260° C. (500° F.). In an aspect, the heat to the rerun column 310 may be supplied from a reboiler 317 using steam. A heavy stream is separated in the rerun column 310 bottoms and taken in line 311. In an embodiment, the heavy stream in line 311 may comprise C₁₀-C₁₆ aromatics and multi-ring aromatics such as biphenyl compounds. A reboil stream is taken in line 315 from the heavy bottoms stream in line 311. The reboil stream in line 315 is heated in the reboiler 317 and a reboiled stream in line 318 is returned to the rerun column 310 near the bottoms. A net heavy stream is taken in line 316 from the bottoms of the rerun column 310.

A rerun column overhead stream comprising toluene is taken in line 312 from the rerun column 310. As previously described, under the aforesaid operating conditions, some of the heavy C₁₂ to C₁₆ hydrocarbons, preferably C₁₄ hydrocarbons, are slipped into the rerun column overhead stream in line 312. In an exemplary embodiment, the rerun column overhead stream in line 312 may comprise about 1 wt % to about 5 wt % C₁₂ to C₁₆ unsaturated hydrocarbons preferably C₁₄ hydrocarbons. In an exemplary embodiment, the rerun column overhead stream in line 312 may comprise about 1 wt % to about 10 wt % C₁₂ to C₁₆ unsaturated hydrocarbons preferably C₁₄ hydrocarbons. The rerun column overhead stream comprising toluene and heavier hydrocarbons in line 312 may be cooled in a heat exchanger 313 and a cooled rerun column overhead stream in line 314 is passed to a rerun column overhead receiver 320. The rerun column overhead stream is further cooled in the rerun overhead receiver 320 to provide a condensed rerun overhead stream comprising toluene and C₁₂ to C₁₆ unsaturated hydrocarbons preferably C₁₄ unsaturated hydrocarbons in line 322. It is possible for air to ingress into the rerun column 310 because it operates below atmospheric pressure. A vacuum pump 323 is provided at the overhead of the rerun column 310 on the rerun column vent stream in line 321 from the overhead receiver 320 to operate the rerun column 310 at vacuum pressure. The vacuum pump 323 provides a rerun column offgas stream in line 324, which may be sent to a thermal oxidizer for destruction. When the C₁₂ to C₁₆ hydrocarbons are slipped and taken in the rerun column overhead stream in line 312, the heavier hydrocarbons such as C₁₈₊ hydrocarbons are preferably taken in the heavy bottoms stream and taken in line 311 from the bottom of the rerun column 310.

The condensed overhead stream comprising toluene and C₁₂ to C₁₆ unsaturated heavy hydrocarbons in line 322 may be taken as the hydrogen carrier and passed to the hydrogenation process 101 for carrying hydrogen in FIG. 1. In an embodiment, the condensed overhead stream in line 322 is combined with the liquid product stream in line 305 to provide a combined stream in line 334. The combined stream in line 334 may be taken as a hydrogen carrier and passed to the line 102 for carrying hydrogen in FIG. 1. The combined stream in line 334 is a product dehydrogenated bottom stream from the fractionation column 270 comprising about 1 to about 10 wt % C₁₂ to C₁₆ hydrocarbons and at least about 80 wt % toluene. In another embodiment, the product dehydrogenated bottom stream in line 334 from the fractionation column 270 may comprise about 1 to about 10 wt % C₁₂ to C₁₆ hydrocarbons and at least about 80 wt % toluene. In aspect, the product dehydrogenated bottom stream in line 334 from the fractionation column 270 may comprise about 1 to about 10 wt % C₁₃ to C₁₅ hydrocarbons.

In aspect, the product dehydrogenated bottom stream in line 334 from the fractionation column 270 may comprise about 1 to about 10 wt % C₁₄ hydrocarbons.

The hydrogen carrier comprising toluene and C₁₂ to C₁₆ unsaturated hydrocarbons in line 322 are taken from the purification section 251. In the embodiment shown in FIG. 2, the purification section 251 is direct, proximate, downstream communication with the dehydrogenation section 203 of the dehydrogenation process 201.

In an alternate embodiment, the purification section 251 may be provided in direct, upstream communication with the hydrogenation section 131 of the hydrogenation process 101 shown in FIG. 1 for providing the hydrogen carrier in line 322 and 334. In the alternate embodiment, the dehydrogenated separator liquid stream in line 267 may be stored or transported and then taken as a feed and passed to the purification section 251 of the hydrogenation section 131. The hydrogenation section 131 with the purification section 251 would be remote from the dehydrogenation section 201 including the separator 255. In the purification section 251, the dehydrogenated separator liquid stream in line 267 is purified to provide the dehydrogenated hydrocarbon stream in line 102 of FIG. 1.

The combined stream in line 334 is a dehydrogenated hydrogen carrier comprising toluene and heavier C₁₂ to C₁₆ unsaturated hydrocarbons such as C₁₂ to C₁₆ aromatics. In an embodiment, the C₁₂ to C₁₆ aromatics are multi-ring aromatics comprising methyl-substituted biphenyls and methyl-substituted fluorenes. In an exemplary embodiment, the combined stream in line 334 comprises C₁₄ aromatics such as dimethyl-biphenyls and methyl-fluorenes. In another exemplary embodiment, the combined stream in line 334 may comprise at least about 80 wt % toluene and from about 1 wt % to about 10 wt % C₁₂ to C₁₆ aromatics.

In an aspect, the combined stream in line 334 may comprise at least about 80 wt % toluene and preferably at least about 90 wt % toluene. In an embodiment, the combined stream in line 334 comprises about 1 wt % to about 10 wt % C₁₂ to C₁₆ unsaturated hydrocarbons. In another embodiment, the combined stream in line 334 comprises about 1 wt % to about 10 wt % C₁₃ to C₁₅ unsaturated hydrocarbons. Preferably, the combined stream in line 334 may comprise about 0.5 wt % to about 10 wt % C₁₄ unsaturated hydrocarbons or about 2 wt % to about 8 wt % C₁₄ unsaturated hydrocarbons or about 3 wt % to about 7 wt % C₁₄ unsaturated hydrocarbons.

In accordance with the present disclosure, the rerun column 310 may be operated at an overhead pressure of about 1.4 kPa(a) (0.2 psia) to about 95 kPa(a) (14 psia). In an aspect, the rerun column 310 may be operated in two modes, C₁₄ rejection mode and a C₁₄ retention mode. When the rerun column 310 is operated under the C₁₄ rejection mode, the rerun column 310 may be operated at an overhead pressure of about 34 kPa (a) (5 psia) to about 95 kPa (a) (14 psia). When the rerun column 310 is operated under the C₁₄ rejection mode, C₁₄ hydrocarbons are predominantly concentrated in the net heavy stream in line 316. In C₁₄ retention mode, the rerun column 310 may be operated at an overhead pressure of about 1.4 kPa (a) (0.2 psia) to about 34 kPa (a) (5 psia). In the C₁₄ retention mode, C₁₂ to C₁₆ unsaturated hydrocarbons are allowed to enter into the rerun column overhead stream in line 312 along with the toluene and routed in the condensed overhead stream in line 322 to be used as a hydrogen carrier. In an aspect, the rerun column 310 may be operated at conditions including the overhead pressure and the bottom temperature to produce a rerun overhead stream comprising toluene and C₁₂ to C₁₆ hydrocarbons in line 312 and a rerun column bottoms stream comprising C18+ hydrocarbons in line 311. In the C₁₄ rejection mode, the flow of the liquid product stream in line 305 may be adjusted the control valve 37 to admit heavy unsaturated hydrocarbons in line 274 into the combined stream in line 334. This way the combined stream in line 334 when taken as the hydrogen carrier comprises about 1 wt % to about 10 wt % C₁₂ to C₁₆ unsaturated hydrocarbons.

### EXAMPLE

The rerun column 310 was operated under C₁₄ retention mode. C₁₄ hydrocarbons were allowed to enter into the rerun column overhead stream in line 312 along with the toluene. In a comparative process with only toluene in the overhead stream, about 970 MJ/tonne of hydrogen product was required to remove the C₁₄ hydrocarbons. For the present process in C₁₄ retention mode, the amount was reduced by a factor of 20 to 49 MJ/tonne hydrogen. This in turn reduced the carbon intensity of the hydrogen by 0.1 kg carbon dioxide (eq)/kg hydrogen. Also, C₁₄ hydrocarbons carried about 40% more hydrogen per barrel than the comparative process. With a mixture of 10% C₁₄ hydrocarbons in toluene, the transport capacity was increased by 4%.

### Specific Embodiments

While the following is described in conjunction with specific embodiments, it will be understood that this description is intended to illustrate and not limit the scope of the preceding description and the appended claims.

A first embodiment of the present disclosure is a process of carrying hydrogen on a hydrogen carrier, comprising hydrogenating a hydrocarbon feed stream in a hydrogenation reactor in the presence of hydrogen and a hydrogenation catalyst to produce a hydrogenated stream for carrying hydrogen; contacting the hydrogenated stream with a dehydrogenation catalyst to produce a dehydrogenated stream; fractionating the dehydrogenated stream in a fractionation column to produce a fractionation column overhead stream comprising C7− hydrocarbons and a fractionation column bottoms stream; and taking the hydrocarbon feed stream comprising about 1 to about 10 wt % C₁₂ to C₁₆ hydrocarbons from the fractionation column bottoms stream. An embodiment of the present disclosure is one, any or all of prior embodiments in this paragraph up through the first embodiment in this paragraph, wherein fractionating the dehydrogenated stream further comprises separating the fractionation column bottoms stream into a liquid product stream and a rerun column feed stream; fractionating the rerun column feed stream to provide a rerun overhead stream comprising toluene and a rerun bottoms stream comprising C₁₂ to C₁₆ hydrocarbons; and taking the hydrocarbon feed stream from the rerun overhead stream. An embodiment of the present disclosure is one, any or all of prior embodiments in this paragraph up through the first embodiment in this paragraph further comprising combining the rerun overhead stream with the liquid product stream to provide a combined stream; and taking the hydrocarbon feed stream comprising at least about 80 wt % toluene from the combined stream. An embodiment of the present disclosure is one, any or all of prior embodiments in this paragraph up through the first embodiment in this paragraph, wherein the combined stream comprises about 1 wt % to about 10 wt % C₁₄ hydrocarbons. An embodiment of the present disclosure is one, any or all of prior embodiments in this paragraph up through the first embodiment in this paragraph, wherein the rerun column is operated at an overhead gauge pressure of about 32 kPa(a) (4.7 psia) to about 95 kPa(a) (13.8 psia). An embodiment of the present disclosure is one, any or all of prior embodiments in this paragraph up through the first embodiment in this paragraph further comprising condensing the rerun overhead stream to provide a condensed overhead stream; and combining the condensed overhead stream with the liquid product stream to provide the combined stream. An embodiment of the present disclosure is one, any or all of prior embodiments in this paragraph up through the first embodiment in this paragraph, wherein contacting the hydrogenated stream with the dehydrogenation catalyst produces C₁₂ to C₁₆ hydrocarbons. An embodiment of the present disclosure is one, any or all of prior embodiments in this paragraph up through the first embodiment in this paragraph further comprising separating the dehydrogenated stream into a vapor dehydrogenated stream comprising hydrogen and a liquid dehydrogenated stream; and fractionating the liquid dehydrogenated stream in the fractionation column. An embodiment of the present disclosure is one, any or all of prior embodiments in this paragraph up through the first embodiment in this paragraph further comprising separating hydrogen from the fractionation column overhead stream in a stabilizer. An embodiment of the present disclosure is one, any or all of prior embodiments in this paragraph up through the first embodiment in this paragraph, wherein the hydrogenation reactor is operated in vapor phase. An embodiment of the present disclosure is one, any or all of prior embodiments in this paragraph up through the first embodiment in this paragraph, wherein the hydrogenated stream is dehydrogenated in a downstream location to produce the dehydrogenated stream.

A second embodiment of the present disclosure is a process of carrying hydrogen on a hydrogen carrier, comprising contacting a hydrocarbon feed stream with a dehydrogenation catalyst to produce a dehydrogenated stream; fractionating the dehydrogenated stream in a fractionation column to produce a fractionation column overhead stream comprising C7− hydrocarbons and a fractionation column bottoms stream comprising toluene and C₁₂ to C₁₆ hydrocarbons; and taking a product dehydrogenated bottom stream comprising toluene and about 1 to about 10 wt % C₁₂ to C₁₆ hydrocarbons and at least about 80 wt % toluene from the fractionation column bottoms stream. An embodiment of the present disclosure is one, any or all of prior embodiments in this paragraph up through the second embodiment in this paragraph, wherein fractionating the dehydrogenated stream further comprising separating the fractionation column bottoms stream into a liquid product stream and a rerun column feed stream; fractionating the rerun column feed stream to provide a rerun overhead stream comprising about 1 wt % to about 5 wt % C₁₂ to C₁₆ hydrocarbons and a rerun bottoms stream comprising heavier hydrocarbons; and hydrogenating the rerun feed stream to produce the hydrogenated stream. An embodiment of the present disclosure is one, any or all of prior embodiments in this paragraph up through the second embodiment in this paragraph further comprising combining the rerun overhead stream with the liquid product stream to provide a combined stream comprising at least about 80 wt % toluene; and hydrogenating the combined stream to produce the hydrogenated stream. An embodiment of the present disclosure is one, any or all of prior embodiments in this paragraph up through the second embodiment in this paragraph, wherein the combined stream comprises about 1 wt % to about 10 wt % C₁₄ hydrocarbons. An embodiment of the present disclosure is one, any or all of prior embodiments in this paragraph up through the second embodiment in this paragraph further comprising separating the dehydrogenated stream into a vapor stream comprising hydrogen and a liquid dehydrogenated stream; and fractionating the liquid dehydrogenated stream in the fractionation column. An embodiment of the present disclosure is one, any or all of prior embodiments in this paragraph up through the second embodiment in this paragraph, wherein the rerun overhead stream comprises toluene and C₁₂ to C₁₆ hydrocarbons and the rerun bottoms stream comprises C₁₈₊ hydrocarbons.

A third embodiment of the present disclosure is a process of carrying hydrogen on a hydrogen carrier, comprising hydrogenating a hydrocarbon feed stream in a hydrogenation reactor in the presence of hydrogen and a hydrogenation catalyst to produce a hydrogenated stream for carrying hydrogen; contacting the hydrogenated stream with a dehydrogenation catalyst to produce a dehydrogenated stream; fractionating the liquid dehydrogenated stream in a fractionation column to produce a fractionation column overhead stream comprising C7− hydrocarbons and a fractionation column bottoms stream comprising 1-10 wt % C₁₂ to C₁₆ hydrocarbons; taking a liquid product stream from the fractionation column bottoms stream; fractionating a rerun column feed stream taken from the fractionation column bottoms stream to provide a rerun overhead stream and a rerun bottoms heavy stream; and taking the hydrocarbon feed stream from the liquid product stream, or the rerun overhead stream or both. An embodiment of the present disclosure is one, any or all of prior embodiments in this paragraph up through the third embodiment in this paragraph, wherein the rerun overhead stream comprises about 1 wt % to about 5 wt % C₁₂ to C₁₆ hydrocarbons An embodiment of the present disclosure is one, any or all of prior embodiments in this paragraph up through the third embodiment in this paragraph further comprising combining the rerun overhead stream with the liquid product stream to provide a combined stream comprising at least about 80 wt % toluene; and taking the hydrocarbon feed stream from the combined stream An embodiment of the present disclosure is one, any or all of prior embodiments in this paragraph up through the third embodiment in this paragraph further comprising condensing the rerun overhead stream to provide a toluene stream; and combining the toluene stream with the liquid product stream to provide the combined stream.

A fourth embodiment of the present disclosure is a hydrocarbon composition comprising about 1 to about 10 wt % C₁₂ to C₁₆ hydrocarbons and at least about 80 wt % toluene. An embodiment of the present disclosure is one, any or all of prior embodiments in this paragraph up through the third embodiment in this paragraph, wherein hydrocarbon composition comprises about 1 to about 10 wt % C₁₃ to C₁₅ hydrocarbons. An embodiment of the present disclosure is one, any or all of prior embodiments in this paragraph up through the third embodiment in this paragraph, wherein hydrocarbon composition comprises about 0.5 to about 10 wt % C₁₄ hydrocarbons.

A fifth embodiment of the present disclosure is a hydrocarbon composition comprising about 1 to about 10 wt % C₁₂ to C₁₆ hydrocarbons and at least about 80 wt % methylcyclohexane. An embodiment of the present disclosure is one, any or all of prior embodiments in this paragraph up through the third embodiment in this paragraph, wherein the hydrocarbon composition comprises about 1 to about 10 wt % C₁₄ hydrocarbons.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the present disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process of carrying hydrogen on a hydrogen carrier, comprising:
hydrogenating a hydrocarbon feed stream in a hydrogenation reactor in the presence of hydrogen and a hydrogenation catalyst to produce a hydrogenated stream;
contacting said hydrogenated stream with a dehydrogenation catalyst to produce a dehydrogenated stream;
fractionating said dehydrogenated stream in a fractionation column to produce a fractionation column overhead stream comprising C₇₋ hydrocarbons and a fractionation column bottoms stream; and
taking said hydrocarbon feed stream comprising about 1 to about 10 wt % C₁₂ to C₁₆ hydrocarbons from said fractionation column bottoms stream.

2. The process of claim 1, wherein fractionating said dehydrogenated stream further comprises:
separating said fractionation column bottoms stream into a liquid product stream and a rerun column feed stream;
fractionating said rerun column feed stream to provide a rerun overhead stream comprising toluene and a rerun bottoms stream comprising C₁₂ to C₁₆ hydrocarbons; and
taking said hydrocarbon feed stream from said rerun overhead stream.

3. The process of claim 2 further comprising:
combining said rerun overhead stream with said liquid product stream to provide a combined stream; and
taking said hydrocarbon feed stream comprising at least about 80 wt % toluene from said combined stream.

4. The process of claim 3, wherein said combined stream comprises about 1 wt % to about 10 wt % C₁₄ hydrocarbons.

5. The process of claim 4, wherein the rerun column is operated at an overhead pressure of about 1.4 kPa(a) (0.2 psia) to about 34 kPa(a) (5 psia).

6. The process of claim 3 further comprising:
condensing said rerun overhead stream to provide a condensed overhead stream; and
combining said condensed overhead stream with said liquid product stream to provide said combined stream.

7. The process of claim 1, wherein contacting said hydrogenated stream with the dehydrogenation catalyst produces C₁₂ to C₁₆ hydrocarbons.

8. The process of claim 1 further comprising:
separating said dehydrogenated stream into a vapor stream comprising hydrogen and a dehydrogenated liquid stream; and
fractionating said dehydrogenated liquid stream in the fractionation column.

9. The process of claim 1 further comprising separating hydrogen from said fractionation column overhead stream in a stabilizer.

10. The process of claim 1, wherein the hydrogenation reactor is operated in vapor phase.

11. The process of claim 1, wherein said hydrogenated stream is dehydrogenated in a downstream location to produce said dehydrogenated stream.

12. A process of carrying hydrogen on a hydrogen carrier, comprising:
contacting a hydrocarbon feed stream with a dehydrogenation catalyst to produce a dehydrogenated stream;
fractionating said dehydrogenated stream in a fractionation column to produce a fractionation column overhead stream comprising C7− hydrocarbons and a fractionation column bottoms stream comprising toluene and C₁₂ to C₁₆ hydrocarbons; and
taking a product dehydrogenated bottom stream comprising toluene and about 1 to about 10 wt % C₁₂ to C₁₆ hydrocarbons and at least about 80 wt % toluene from said fractionation column bottoms stream.

13. The process of claim 12, wherein fractionating said dehydrogenated stream further comprising:
separating said fractionation column bottoms stream into a liquid product stream and a rerun column feed stream;
fractionating said rerun column feed stream to provide a rerun overhead stream comprising C₁₂ to C₁₆ hydrocarbons and a rerun bottoms stream comprising heavier hydrocarbons; and
hydrogenating said rerun overhead stream to produce a hydrogenated stream.

14. The process of claim 13 further comprising:
combining said rerun overhead stream with said liquid product stream to provide a combined stream comprising at least about 80 wt % toluene; and
hydrogenating said combined stream to produce said hydrogenated stream.

15. The process of claim 14, wherein said combined stream comprises about 0.5 wt % to about 10 wt % C₁₄ hydrocarbons.

16. The process of claim 12 further comprising:
separating said dehydrogenated stream into a vapor stream comprising hydrogen and a liquid dehydrogenated stream; and
fractionating said liquid dehydrogenated stream in the fractionation column.

17. The process of claim 1, wherein said rerun overhead stream comprises toluene and C₁₂ to C₁₆ hydrocarbons and said rerun bottoms stream comprises C₁₈₊ hydrocarbons.

18. A hydrocarbon composition comprising about 1 to about 10 wt % C₁₂ to C₁₆ hydrocarbons and at least about 80 wt % toluene.

19. The composition of claim 18 comprising about 1 to about 10 wt % C₁₃ to C₁₅ hydrocarbons.

20. The composition of claim 18 comprising about 1 to about 10 wt % C₁₄ hydrocarbons.
